(19) United States
(12) Patent Application Publication
(10) Pub. No.: US 2007/0204450 A1
(43) Pub. Date: Sep. 6, 2007

(54) Method for forming net-cloth enclosed chair

(76) Inventor: Tsung-Chieh Huang, Kaohsiung Hsien (TW)

Correspondence Address: TSUNG-CHIEH HUANG, 235 Chung-Ho, Box 8-24, Taipei, TW

(21) Appl. No.: 11/368,009

(22) Filed: Mar. 6, 2006

(51) Int. Cl. B68G 7/00; B21B 1/46

(52) U.S. Cl. 29/91; 29/91.1; 29/527.2

(57) ABSTRACT

A method for forming a chair comprises the following steps of forming an inner frame of a chair frame by molding injection; enclosing the net cloth around the inner frame of the chair frame; and enclosing an enclosing layer upon the net cloth and the chair frame by injection molding. The chair frame is made of non-metal material. The chair frame has predetermined colors. The net cloth is one of a fabric net cloth, fiber net cloth, non-fiber net cloth, leather net cloth, plastic net cloth, rubber net cloth, manmade net cloth, manmade leather net cloth. The enclosing layer is formed by elastic materials. The enclosing layer is made by one of plastic materials, rubber materials, or foaming materials, and synthetic materials. The enclosing layer has predetermined colors. The enclosing layer is partially or wholly enclose the net cloth.

### FIELD OF THE INVENTION

The present invention relates to a method for forming a net-cloth enclosed chair which comprises the following steps of forming an inner frame of a chair frame by molding injection; enclosing the net cloth around the inner frame of the chair frame; and enclosing an enclosing layer upon the net cloth and the chair frame by injection molding.

### BACKGROUND OF THE INVENTION

Net chair provides the function of comfort feeling and air ventilation which is preferable than the prior art chair.

In the manufacturing process of the net chair, firstly, an inner frame is made. A net cloth encloses the inner frame. An outer frame encloses the net cloth and the inner frame. Screws and other retainers are used to fix the structure. However the assembly work is tedious and time-consumed. Thereby the screws and retainers are exposed out, which has an unbeautiful outlook,

The U.S. Pat. Nos. 6,065,197 and 6,292,990 disclose the manufacturing process of net cloth. However the prior arts have the following disadvantages.

In the manufacturing process, the chair frame must be made of metal which can suffer from to a temperature of 300 degrees. The net cloth must be placed into a metal mold and is clamped therein. The chair frame is combined to the net cloth by heating and filling resin. The net cloth is not directly fixed to the chair frame and is combined with the chair frame. In the manufacturing electric heat energy and cooling system are necessary. The cost is high and assembly work is tedious. Further, the net cloth is not directly fixed to the chair frame and is combined with the chair frame. The net cloth is not directly fixed to the chair frame. The elasticity of the resin covered thereon is not good. Moreover the outer enclosing layer is hard. The appearance of the look is not preferred. The chair frame is made of metal material. The chair frame must be performed with surface processing steps, such as bending, welding, etc. The cost is high and time is consumed. Further, it has no wide utility and is not economical.

### SUMMARY OF THE INVENTION

Accordingly, the primary object of the present invention is to provide a method for manufacturing a net-cloth enclosed chair which combines a net cloth and a chair frame. The net cloth may be a fabric net cloth, or a fiber net cloth, a non-fiber net cloth, a leather net cloth, plastic net cloth, or rubber net cloth, or other manmade net cloth, manmade leather net cloth etc. The present invention includes the following steps of: Forming an inner frame of a chair frame by molding injection, wherein the chair frame is made of non-metal material. The chair frame has predetermined colors. Tightly enclosing the net cloth around the inner frame of the chair frame by high frequency sound wave combination, or riveting or other ways. Enclosing an enclosing layer upon the net cloth and the chair frame by injection molding. The enclosing layer is formed of elastic materials, such as plastic materials, rubber materials, or foaming materials, or other synthetic materials. The enclosing layer has predetermined colors. The enclosing layer can partially or wholly enclose the net cloth. The colors of the enclosing layer can be matched to the colors of the net cloth so as to have a preferred outlook.

The various objects and advantages of the present invention will be more readily understood from the following detailed description when read in conjunction with the appended drawing.

### BRIEF DESCRIPTION OF THE DRAWINGS

FIG. 1 shows the chair frame of the present invention.

FIG. 2 is a schematic view about the first step of the present invention.

FIG. 3 is a schematic view about the second step of the present invention.

FIG. 4 is a schematic view about the third step of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

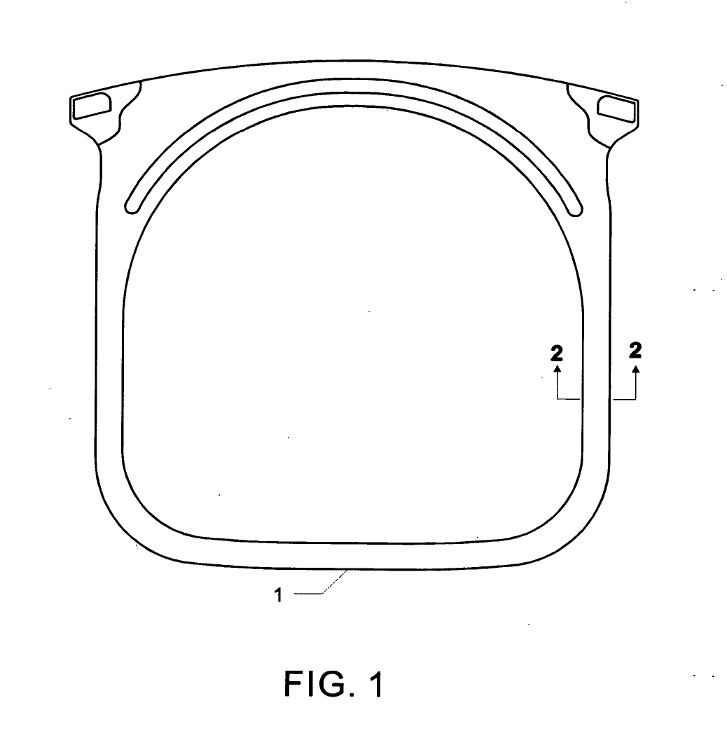

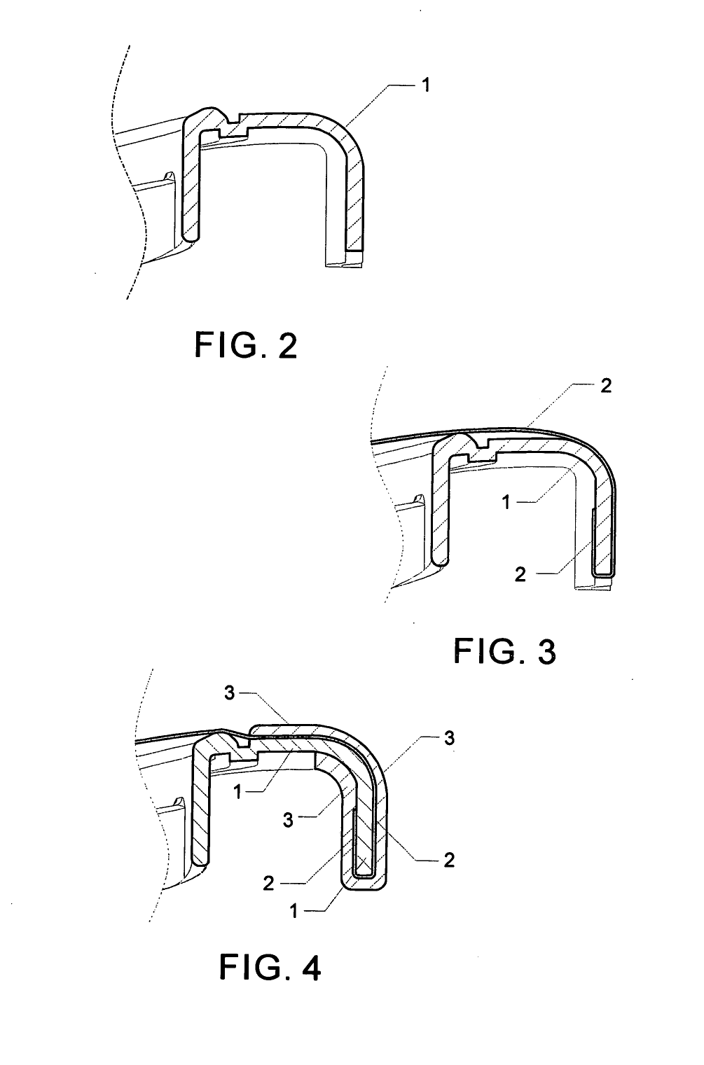

Referring to FIGS. 1 to 4, the structure about the present invention is illustrated. The present invention is related to a method for manufacturing a chair which combines a net cloth 2 (a cloth is formed as a net) and a chair frame 1. The net cloth 2 may be a fabric net cloth, or a fiber net cloth, a non-fiber net cloth, a leather net cloth, plastic net cloth, or rubber net cloth, or other manmade net cloth 2, manmade leather net cloth 2 etc. The present invention includes the following steps of:

Forming an inner frame of a chair frame 1 by molding injection, wherein the chair frame 1 is made of non-metal material. The chair frame 1 has predetermined colors.

Tightly enclosing the net cloth 2 around the inner frame of the chair frame 1 by high frequency sound wave combination, or riveting or other ways.

Enclosing an enclosing layer 3 upon the net cloth 2 and the chair frame 1 by injection molding. The enclosing layer 3 is formed of elastic materials, such as plastic materials, rubber materials, or foaming materials, or other synthetic materials. The enclosing layer 3 has predetermined colors. The enclosing layer 3 can partially or wholly enclose the net cloth 2. The colors of the enclosing layer 3 can be matched to the colors of the net cloth 2 so as to have a preferred outlook.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for forming a net-cloth enclosed chair comprising the following steps of:
forming an inner frame of a chair frame by molding injection;
enclosing the net cloth around the inner frame of the chair frame; and
enclosing an enclosing layer upon the net cloth and the chair frame by injection molding.

2. The method as claimed in claim 1, wherein the chair frame is made of non-metal material.

3. The method as claimed in claim 1, wherein the chair frame has predetermined colors.

4. The method as claimed in claim 1, wherein the net cloth is one of a fabric net cloth, fiber net cloth, non-fiber net cloth, leather net cloth, plastic net cloth, rubber net cloth, manmade net cloth, manmade leather net cloth.

5. The method as claimed in claim 1, wherein the enclosing layer is formed by elastic materials.

6. The method as claimed in claim 1, wherein the enclosing layer is made by one of plastic materials, rubber materials, or foaming materials, and synthetic materials.

7. The method as claimed in claim 1, wherein the enclosing layer 3 has predetermined colors.

8. The method as claimed in claim 1, wherein the enclosing layer is partially or wholly enclose the net cloth.
